(19) United States
(12) Patent Application Publication
(10) Pub. No.: US 2021/0032460 A1
(43) Pub. Date: Feb. 4, 2021

(54) HOOK FOR SUSPENDING CABLES OR HOSE PIPES

(71) Applicant: PENSIOEN B.V., Leusden (NL)

(72) Inventors: Maurits Frederik WESTERBEEK VAN EERTEN, Leusden (NL); David Constantijn WESTERBEEK VAN EERTEN, Leusden (NL)

(73) Assignee: PENSIOEN B.V., Leusden (NL)

(21) Appl. No.: 17/070,169

(22) Filed: Oct. 14, 2020

Related U.S. Application Data
(63) Continuation of application No. PCT/EP2019/059310, filed on Apr. 11, 2019.

(51) Int. Cl. C08L 67/02; C08K 7/14; F16L 3/06; B29L 31/00; B29K 67/00; B29K 105/00; B29K 309/08; B29C 45/00

(52) U.S. Cl. CPC C08L 67/02; C08K 7/14; F16L 3/06; B29L 2031/738; B29K 2105/0044; B29K 2067/006; B29K 2105/0026; B29K 2309/08; B29C 45/0001; B29K 2995/0016

(57) ABSTRACT

An improved hook for cable management during maintenance, turnarounds, construction works and industrial works. An improved hook of an injection molded glass-fiber reinforced thermoplastic resin for suspending cables or hose pipes. The hooks are capable of safely bearing high loads in the range of 30 to 400 kg. Methods for providing the present improved hooks, specifically hooks for suspending cables and hoses, where the hooks are comprised of 45 to 800 grams of an injection molded composition comprised of a polybutylene terephthalate resin, 18% to 22% per total weight of the composition glass-fiber, one or more flame retardants and one or more UV stabilizers; and the hooks have a maximum load bearing of 0.3 to 0.8 kg per gram composition.

### CROSS-REFERENCE TO RELATED APPLICATION

This is a continuation of international patent application serial number PCT/EP2019/059310, filed Apr. 11, 2019, the entirety of which application is incorporated by reference herein.

### FIELD OF THE INVENTION

The present invention relates to an improved hook for cable management during, for example, maintenance, turnarounds, construction works and industrial works. The present invention especially relates to an improved hook of an injection molded glass-fiber reinforced thermoplastic resin for suspending cables or hose pipes. The present improved hooks are capable of safely bearing high loads in the range of 30 to 400 kg. The present invention also relates to methods for providing the present improved hooks.

### BACKGROUND OF THE INVENTION

Hooks are well-known and are used on a wide scale for fastening and/or bearing cables or hose pipes such as, for example, electricity cables, welding cables, air hoses, hydraulic hoses and fire hoses. The hooks are useful wherever such cables or hose pipes are used. Examples are the (petro)chemical industry, the offshore industry, the steel and aluminum industry, the ship building industry, oil and gas extraction, the mining industry, the prefabricated construction industry and power stations. Suspending the cables or hose pipes from the wall or the ceiling prevents people tripping over them. Moreover, it reduces the risk of cables or hose pipes becoming damaged, which could result in the leaking of noxious substances or the occurrence of short circuiting, with the consequence of fire hazard.

Although cables and hose pipes can be fastened to the ceiling or to the wall by means of conventional hooks, the danger of unintentional and undesirable contact still exists, with the above-mentioned associated hazards. One can easily bump into such hook or the cables or hose pipes it carries, at the risk of, for example, head injuries. Moving hooks with wires of cables such as, for example, aboard a ship is extremely dangerous and may cause lethal injuries.

European patent EP 1 505 326 discloses a hook for bearing cables or hose pipes providing improved safety for cable management. However, under conditions such as fire. cold, heat or prolonged light exposure, particularly occurring in more extreme natural or manmade environments, improved safety for cable management is desired and increasingly demanded in the art and imposed by industry standards.

Accordingly, there is a need in the art for an improved hook for bearing or suspending cables and hoses. The present need in the art is especially a need in the context of (heavy) industrial applications such as in the (petro)chemical industry, the offshore industry, the steel and aluminum industry, the ship building industry, oil and gas extraction, the mining industry, the prefabricated construction industry and power stations and plants.

### SUMMARY OF THE INVENTION

It is an object of the present invention, amongst other objects, to meet the above need in the art.

According to the present invention, the above object, amongst other objects, is met by hooks, methods and uses as outlined in the appended claims.

Specifically, the above object, amongst other objects, is met by hooks for suspending cables and hoses, wherein the hooks are comprised of 45 to 800 grams of an injection molded composition comprised of polybutylene terephthalate, or PBT, 18% to 22% per total weight of the composition glass-fiber, one or more flame retardants and one or more UV stabilizers; and the hooks have a maximum load bearing of 0.3 to 0.8 kg per gram composition. Within the context of the present invention, the further addition of pigments and some polyethylene (PET) to the composition are contemplated.

The present hooks meet a new industry standard that came into effect at the start of 2019. The present hooks prevent slips, trips and falls incidents, which account for a third of all reported major injuries. Often these accidents result in broken ankles, wrists or other fractures. British Standard recently adopted the Requirements for Electrical Installations [BS7671:2018] for the electrical design industry. This standard is developed after the deaths of two firefighters at Harrow Court, Hertfordshire, in 2005. The two firefighters got entangled as a result of the collapse of an electrical installation during a fire. The implemented standard states that it requires cables to be adequately supported against their premature collapse in the event of a fire.

The present hooks, although providing a similar load bearing capacity, are different from the hooks disclosed in EP 1 505 326 with respect to, for example, thermoplastic resin and UV resistance. Further, the hooks are flame retardant. For example, the present hooks with a dimension (h) of 38 cm can safely carry 265 kg static load, of 30 cm 190 kg static load, of 23 cm 75 kg static load and of 15 cm 40 kg static load.

### BRIEF DESCRIPTION OF THE DRAWINGS

FIG. 1 is a side view of a hook according to embodiments of the invention.

FIG. 2 is a side view of another hook according to embodiments of the invention.

### DETAILED DESCRIPTION

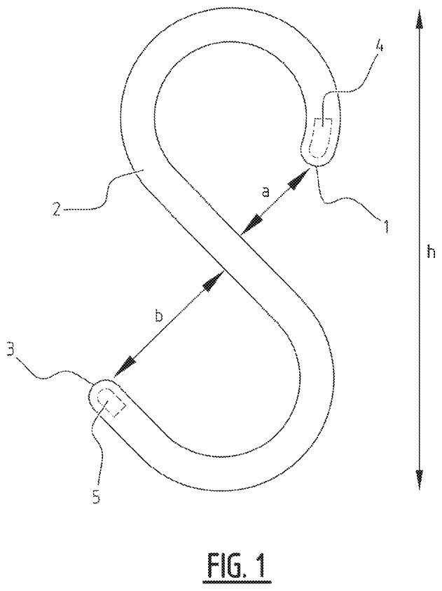

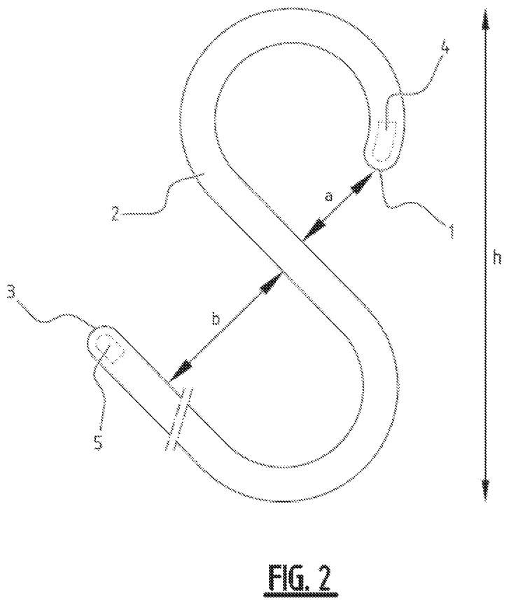

According to a preferred embodiment, the present hooks for suspending cables and hoses have the shape of a hook depicted in FIGS. 1 and 2.

The hook illustrated in FIGS. 1 and 2 comprise a first spherical end 1 and a second spherical end 3, which spherical ends are connected with each other by an S-shaped body 2. The first spherical end 1 is optionally provided with an opening 4. The second spherical end 3 is optionally provided with an opening 5. With the aid of these openings the hook may be secured, for example, with plastic binders. The height h of the hook may vary from 5 to 75 cm. Suitable values for a are between 2 to 8 cm, such as 3, 4, 5, 6 or 7 cm and for b 2 to 15 cm, such as 3, 4, 5, 6, 7, 8, 9, 10, 11, 12, 13 or 14 cm.

Polybutylene terephthalate, or PBT, is a thermoplastic engineering polymer that is used, amongst others, as an insulator in the electrical and electronics industries. It is a thermoplastic (semi-)crystalline polymer, and a type of polyester. PBT is resistant to solvents, shrinks very little during forming, and is mechanically strong.

According to yet another preferred embodiment, the present one or more flame retardants are selected from the group consisting of minerals, organohalogen compounds and organophosphorus compounds.

The present minerals are preferably selected from the group consisting of aluminums hydroxide, magnesium hydroxide, huntite and hydromagnesite, hydrates, red phosphorus, boron compounds and borates.

The present organohalogen compounds are preferably selected from the group consisting of chlorendic acid derivatives, chlorinated paraffins; organobromines, decabromodiphenyl ether, decabromodiphenyl ethane, polymeric brominated compounds, brominated polystyrenes, brominated carbonate oligomers, brominated epoxy oligomers, tetrabromophthalic anyhydride, tetrabromobisphenol A) and hexabromocyclododecane optionally in combination with antimony tri- or pentoxide or sodium antimonate.

The present organophosphorus compounds are preferably selected from the group consisting of triphenyl phosphate, resorcinol bis(diphenylphosphate), bisphenol A diphenyl phosphate, tricresyl phosphate, phosphonates, dimethyl methylphosphonate, phosphinates, and aluminum diethyl phosphinate.

Other flame retardant contemplated for preferred embodiments of the present invention are flame retardants selected from the group consisting of tris(2,3-dibromopropyl) phosphate, chlorinated organophosphates, tris(1,3-dichloro-2-propyl)phosphate and tetrakis(2-chlorethyl)dichloroisopentyldiphosphate.

Stabilizers are a class of chemical additives commonly added to polymeric materials, such as plastics, to inhibit or retard their degradation. Polymers can be subject to various degradation processes, including oxidation, UV-damage, thermal degradation, ozonolysis, or combinations thereof like photo-oxidation. These processes all degrade the polymer on a chemical level, leading to chain scission that can adversely affect its mechanical properties such as strength and malleability, as well as its appearance and color.

According to the present invention, the present hooks for suspending cables and hoses preferably comprise one or more UV stabilizers selected from the group consisting of oxanilides, benzophenones, benzotriazoles, hydroxyphenyltriazines and hindered amine light stabilizers. The UV absorbers generally dissipate the absorbed light energy from UV rays as heat by reversible intramolecular proton transfer. This reduces the absorption of UV rays by the polymer matrix and hence reduces the rate of degradation and weathering.

The ability of hindered amine light stabilizers (HALS or HAS) to scavenge radicals produced by degradation or weathering may be explained by the formation of aminoxyl radicals through a process known as the Denisov Cycle. The aminoxyl radical (N—O.) combines with free radicals in polymers: N—O.+R.→N—O—R. Although they are traditionally considered as light stabilizers, they can also stabilize thermal degradation.

According to still another preferred embodiment, the present invention relates to hooks for suspending cables and hoses, wherein the present an injection molded composition further comprises heat stabilizers, preferably metallic soaps or calcium stearate.

The present injection molded compositions can preferably further comprise one or more fluorescent compounds or particles.

According to an especially preferred embodiment, the present hooks for suspending cables and hoses are comprised of Valox™ Resin 4521, Arnite® TV4 240 S supplemented with one or more UV stabilizers; or RAMS TER PF321G4NT supplemented with one or more UV stabilizers.

Valox™ Resin 4521 (SABIC Innovative Plastics B.V., Bergen op Zoom, The Netherlands) is a 20% glass filled, high flow, flame retardant polybutylene terephthalate (PBT) of injection moldable grade.

Arnite® TV4 240 S (DSM, Heerlen, The Netherlands) is part of the Arnite® (PBT, PET and blends) family and is a high-performance engineering plastic that combine high strength and rigidity with excellent processing characteristics.

RAMSTER PF321G4NT (Polyram Plastic Industries LTD, Israel) is a 20% glass fiber reinforced, flame Retardant PBT polymer for injection molding applications.

According to another embodiment, the present invention relates to methods for providing the present hooks for suspending cables or hoses, the method comprises the steps of:
a) preparing a mixture of a thermoplastic PBS resin, 18% to 22% per total weight of the composition glass-fiber, one or more flame retardants and one or more UV stabilizers as defined in the embodiments above;
b) drying and compounding the mixture of step (a) to allow injection molding;
c) injecting the compounded mixture of step (b) into a mold for a hook with a shape as depicted in FIG. 1 or 2;
d) cooling and subsequently removing the injection molded hook from the mold.

According to another embodiment, the present invention relates to the use of the present hooks for suspending cables or hoses for (heavy) industrial applications, preferably cable management in the (petro)chemical industry, the offshore industry, the steel and aluminum industry, the ship building industry, oil and gas extraction, the mining industry, the prefabricated construction industry and power stations and plants.

1. A hook for suspending cables and hoses, said hook is comprised of:
45 to 800 grams of an injection molded composition comprised of a polybutylene terephthalate resin,
18% to 22% per total weight of the composition glass-fiber;
one or more flame retardants; and
one or more UV stabilizers; and
wherein said hook has a maximum load bearing of 0.3 to 0.8 kg per gram composition.

2. The hook of claim 1, said hook having first and second spherical ends connected to each other by an S-shaped body, the first spherical end including an opening, the second spherical end including an opening.

3. The hook of claim 1, wherein said one or more flame retardants are selected from the group consisting of minerals, organohalogen compounds and organophosphorus compounds.

4. The hook of claim 3, wherein said minerals are selected from the group consisting of aluminium hydroxide, magnesium hydroxide, huntite and hydromagnesite, hydrates, red phosphorus, boron compounds and borates.

5. The hook of claim 3, wherein said organohalogen compounds are selected from the group consisting of chlorendic acid derivatives, chlorinated paraffins; organobromines, decabromodiphenyl ether, decabromodiphenyl ethane, polymeric brominated compounds, brominated polystyrenes, brominated carbonate oligomers, brominated epoxy oligomers, tetrabromophthalic anyhydride, tetrabromobisphenol A) and hexabromocyclododecane, optionally in combination with antimony tri- or pentoxide or sodium antimonate.

6. The hook of claim 3, wherein said organophosphorus compounds are selected from the group consisting of triphenyl phosphate, resorcinol bis(diphenylphosphate), bisphenol A diphenyl phosphate, tricresyl phosphate, phosphonates, dimethyl methylphosphonate, phosphinates, and aluminium diethyl phosphinate.

7. The hook of claim 1, wherein said one or more flame retardants are selected from the group consisting of tris(2,3-dibromopropyl) phosphate, chlorinated organophosphates, tris(1,3-dichloro-2-propyl)phosphate and tetrakis(2-chlorethyl)dichloroisopentyldiphosphate.

8. The hook of claim 1, wherein said one or more UV stabilizers are selected from the group consisting of oxanilides, benzophenones, benzotriazoles, hydroxyphenyltriazines and hindered amine light stabilizers.

9. The hook of claim 8, wherein said injection molded composition further comprises heat stabilizers.

10. The hook of claim 9, wherein said heat stabilizers are selected from the group consisting of metallic soaps and calcium stearate.

11. The hook of claim 1, wherein said injection molded composition further comprises one or more fluorescent compounds or particles, pigments and/or polyehtylene.

12. The hook of claim 1, wherein said hook is comprised of Valox™ Resin 4521, Amite TV4 240 S supplemented with one or more UV stabilizers; or RAMSTER PF321G4NT supplemented with one or more UV stabilizers.

13. A method for providing a hook for suspending cables or hoses according to claim 1, the method comprising:
a) preparing a mixture of a thermoplastic polyester resin, 18% to 22% per total weight of the mixture glass-fiber, one or more flame retardants and one or more UV stabilizers as defined in claim 1;
b) drying and compounding the mixture of step (a) to allow injection molding;
c) injecting the compounded mixture of step (b) into a mold for a hook, the hook having first and second spherical ends connected to each other by an S-shaped body, the first spherical end including an opening, the second spherical end including an opening; and
d) cooling and subsequently removing the injection molded hook from said mold.

14. The hook of claim 2, wherein a distance between the first spherical end and the S-shaped body is from 2-8 centimeters (cm) and a distance between the second spherical end and the S-shaped body is from 3 cm to 14 cm, and wherein a height of the hook is from 5 to 75 cm.

15. The method of claim 13, wherein a distance between the first spherical end and the S-shaped body is from 2-8 centimeters (cm) and a distance between the second spherical end and the S-shaped body is from 3 cm to 14 cm, and wherein a height of the hook is from 5 to 75 cm
